(19) United States
(12) Patent Application Publication
(10) Pub. No.: US 2016/0267577 A1
(43) Pub. Date: Sep. 15, 2016

(54) HOLOGRAPHIC INTERACTIVE RETAIL SYSTEM

(71) Applicant: VENTANA 3D, LLC, Van Nuys, CA (US)

(72) Inventors: Ashley Crowder, Venice, CA (US); Benjamin Conway, Santa Monica, CA (US); James M. Behmke, Pembroke, MA (US)

(21) Appl. No.: 15/067,879

(22) Filed: Mar. 11, 2016

Related U.S. Application Data
(60) Provisional application No. 62/131,620, filed on Mar. 11, 2015.

(51) Int. Cl. G06Q 30/06; G03H 1/00; G06T 13/40; G06K 9/00; G06F 3/0482; G06F 3/01

(52) U.S. Cl. CPC G06Q 30/0643; G06F 3/0482; G06F 3/017; G06T 13/40; G06K 9/00302; G03H 1/0005; G03H 2001/0055; G03H 2001/0088; G03H 2001/0061

(57) ABSTRACT

Systems and methods herein are directed to a holographic interactive retail system. In particular, various embodiments are described where a holographic image (e.g., Pepper's Ghost Illusion) is used in a retail setting (e.g., storefront window), which, when combined with gesture control, allows people to walk up to the system and search for and buy products. For example, the customers can interact with a holographic sales clerk, and can select holographic products via gesture control. A final purchase can be made through the customer's mobile device or through a self-service kiosk, shipping the product to their house.

### RELATED APPLICATION

This application claims priority to U.S. Provisional Application No. 62/131,620 filed on Mar. 11, 2015 entitled HOLOGRAPHIC INTERACTIVE RETAIL SYSTEM, by Crowder, et al., the contents of which are incorporated herein by reference.

### TECHNICAL FIELD

The present disclosure relates generally to holographic projection, and, more particularly, to a holographic interactive retail system.

### BACKGROUND

Physical retail environments, such as shopping malls, brick-and-mortar stores, vending fronts, etc., have changed very little over time. A person walks into a retail environment, browses through the physical goods for sale, and if they select something in particular to buy, they may take that item to a cashier to complete their purchase. Online retail environments, on the other hand, can offer many more products than a physical retail environment. However, navigating through the seemingly endless online inventory and making a purchase online is a utilitarian and often lonely experience.

### SUMMARY

According to one or more embodiments herein, a holographic interactive retail system is shown and described. In particular, various embodiments are described where a holographic image (e.g., Pepper's Ghost Illusion) is used in a retail setting (e.g., storefront window), which, when combined with gesture control, allows people to walk up to the system and search for and buy products. For example, the customers can interact with a holographic sales clerk, and can select holographic products via gesture control. A final purchase can be made through the customer's mobile device or through a self-service kiosk, shipping the product to their house.

Other specific embodiments, extensions, or implementation details are also described below.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example of well-known holographic projection techniques;

FIG. 2 illustrates an alternative arrangement for a projection-based holographic projection system, namely where the projector is located on the floor, and the bounce is located on the ceiling;

FIG. 3 illustrates an example of a holographic projection system using video panel displays, with the panel below a transparent screen;

FIG. 4 illustrates an example of a holographic projection system using video panel displays, with the panel above a transparent screen;

FIG. 5 illustrates an example simplified holographic projection system (e.g., communication network);

FIG. 6 illustrates a simplified example of a holographic interactive retail system in accordance with one or more embodiments herein;

FIG. 7 illustrates an example of a computing device for use with a holographic interactive retail system in accordance with one or more embodiments herein; and

FIG. 8 illustrates an example of a gesture control system for use with a holographic interactive retail system in accordance with one or more embodiments herein; and

FIGS. 9A-9B illustrate examples of tracked data points obtained from a video processing system in accordance with one or more embodiments herein;

FIG. 10 illustrates an example of using a holographic interactive retail system in accordance with one or more embodiments herein; and

FIGS. 11A-11B illustrate examples of a depth-based video capture device in accordance with one or more embodiments herein;

FIGS. 12A-12E illustrate examples of depth-based user tracking in accordance with one or more embodiments herein;

FIG. 13 illustrates an example of depth-based user tracking for avatar control;

FIG. 14 illustrates an example of sequential skeletal user tracking for avatar control;

FIG. 15 illustrates an example simplified procedure for depth-based user tracking for avatar control in accordance with one or more embodiments described herein

FIG. 16 illustrates an example avatar control system in accordance with one or more embodiments herein;

FIG. 17 illustrates an example of a customer interacting with an avatar that is a holographical projection and is controlled by a user that is either off to the side or in a remote location in accordance with one or more embodiments described herein;

FIG. 18 illustrates an example of a customer's image being holographically displayed with products of a holographic interactive retail system in accordance with one or more embodiments herein;

FIGS. 19A-19B illustrate an example of a customer controlling perspective views of products of a holographic interactive retail system in accordance with one or more embodiments herein;

FIGS. 20A-20B illustrate examples of a customer's image being holographically displayed with products of a holographic interactive retail system as either a two-dimensional image or a three-dimensional image/avatar in accordance with one or more embodiments herein; and

FIG. 21 illustrates an example procedure for using a holographic interactive retail system in accordance with one or more embodiments herein.

### DESCRIPTION OF EXAMPLE EMBODIMENTS

As mentioned above, a holographic interactive retail system is described herein, where a holographic image (e.g., Pepper's Ghost Illusion) may be used in a retail setting (e.g., storefront window), which, when combined with gesture control, allows people to walk up to the system and search for and buy products.

The “Pepper's Ghost Illusion” is an illusion technique known for centuries (named after John Henry Pepper, who popularized the effect), and has historically been used in theatre, haunted houses, dark rides, and magic tricks. It uses plate glass, Plexiglas, or plastic film and special lighting techniques to make objects seem to appear or disappear, become transparent, or to make one object morph into another. Traditionally, for the illusion to work, the viewer must be able to see into a main room, but not into a hidden room. The hidden room may be painted black with only light-colored objects in it. When light is cast on the room, only the light objects reflect the light and appear as ghostly translucent images superimposed in the visible room.

Notably, Pepper's Ghost Illusion systems have generally remained the same since the 19th Century, adding little more over time than the use of projection systems that either direct or reflect light beams onto the transparent angled screen, rather than using live actors in a hidden room. That is, technologies have emerged in the field of holographic projection that essentially mimic the Pepper's Ghost Illusion, using projectors as the light source to send a picture of an object or person with an all-black background onto a flat, high-gain reflection surface (also referred to as a “bounce”), such as white or grey projection screen. The bounce is typically maintained at an approximate 45-degree angle to the transparent screen surface.

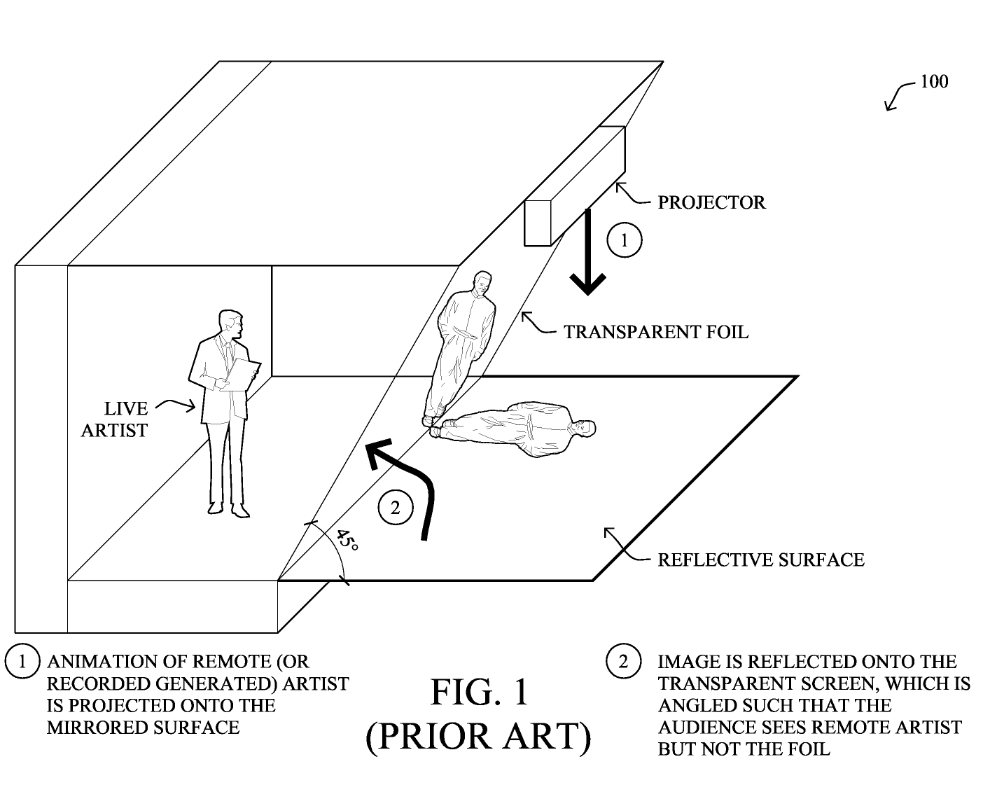

For example, a recent trend in live music performances has been to use a holographic projection of a performer (e.g., live-streamed, pre-recorded, or re-constructed). FIG. 1 illustrates an example of a conventional (generally large-scale) holographic projection system 100. Particularly, the streamed (or recorded, or generated) image of the artist (or other object) may be projected onto a reflective surface, such that it appears on an angled screen and the audience sees the artist or object and not the screen. If the screen is transparent, this allows for other objects, such as other live artists, to stand in the background of the screen, and to appear to be standing next to the holographic projection when viewed from the audience.

As noted above, the “Pepper's Ghost Illusion” is an illusion technique that uses plate glass, Plexiglas, or plastic film and special lighting techniques to make holographic projections of people or objects. FIG. 1, in particular, illustrates an example of holographic projection using projectors as the light source to send a picture of an object or person with an all-black background onto a flat, high-gain reflection surface (or “bounce”), such as white or grey projection screen. The bounce is typically maintained at an approximate 45-degree angle to the transparent screen surface.

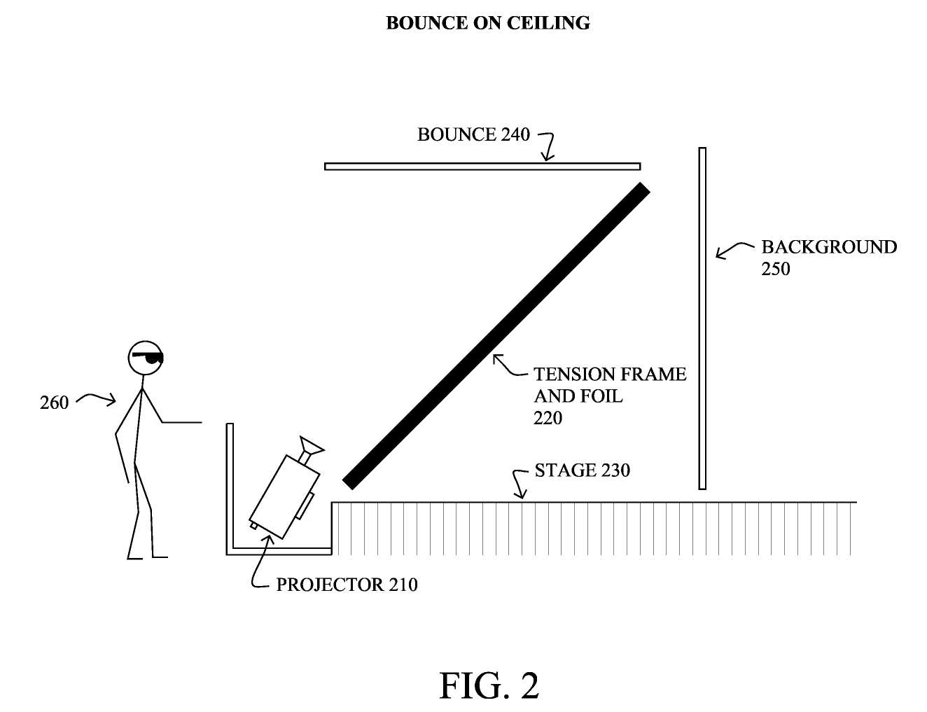

FIG. 2 illustrates an alternative arrangement for a projection-based holographic projection system, namely where the projector 210 is located on the floor, and the bounce 240 is located on the ceiling. The stick figure illustrates the viewer 260, that is, from which side one can see the holographic projection. In this arrangement, the same effect can be achieved as in FIG. 1, though there are various considerations as to whether to use a particular location of the projector 210 as in FIG. 1 or FIG. 2.

Though the projection-based system is suitable in many situations, particularly large-scale uses, there are certain issues with using projectors in this manner. For example, if atmosphere (e.g., smoke from a fog machine) is released, the viewer 260 can see where the light is coming from, thus ruining the effect. Also, projectors are not typically bright enough to shine through atmosphere, which causes the reflected image to look dull and ghost-like. Moreover, projectors are large and heavy which leads to increased space requirements and difficulty rigging.

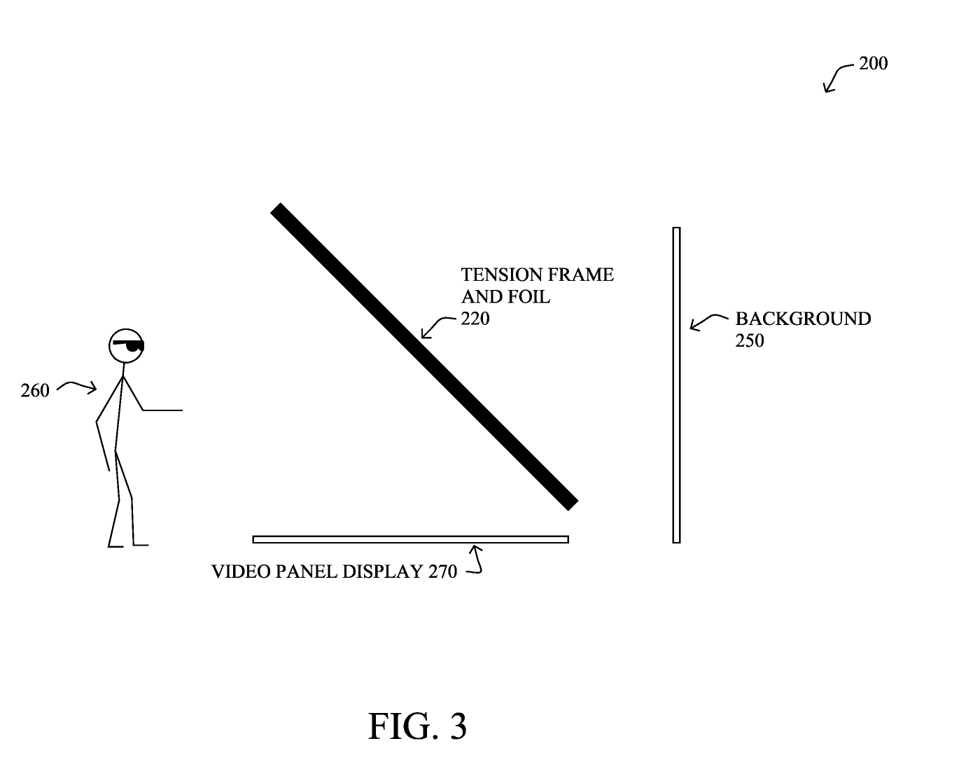

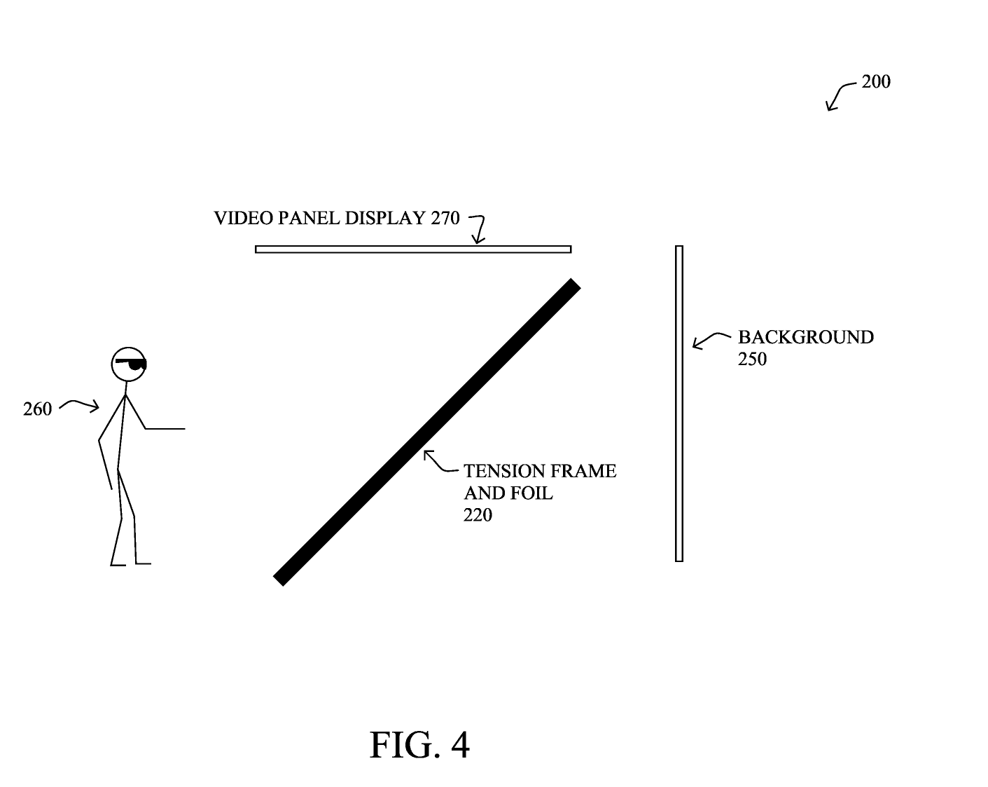

Another example holographic projection system, therefore, with reference generally to FIGS. 3 and 4, may be established with video panel displays 270, such as LED or LCD panels, mobile phones, tablets, laptops, or monitors as the light source, rather than a projection-based system. In particular, these panel-based systems allow for holographic projection for any size setup, such as from personal “mini” displays (e.g., phones, tablets, etc.) up to the larger full-stage-size displays (e.g., with custom-sized LCD or LED panels). Similar to the typical arrangement, a preferred angle between the image light source and the reflective yet transparent surface (clear screen) is an approximate 45-degree angle, whether the display is placed below the transparent screen (FIG. 3) or above it (FIG. 4).

Again, the stick figure illustrates the viewer 260, that is, from which side one can see the holographic projection. Note that the system typically provides about 165-degrees of viewing angle. (Also note that various dressings and props can be designed to hide various hardware components and/or to build an overall scene, but such items are omitted for clarity.)

The transparent screen is generally a flat surface that has similar light properties of clear glass (e.g., glass, plastic such as Plexiglas or tensioned plastic film). As shown, a tensioning frame 220 is used to stretch a clear foil into a stable, wrinkle-free (e.g., and vibration resistant) reflectively transparent surface (that is, displaying/reflecting light images for the holographic projection, but allowing the viewer to see through to the background). Generally, for larger displays it may be easier to use a tensioned plastic film as the reflection surface because glass or rigid plastic (e.g., Plexiglas) is difficult to transport and rig safely.

The light source itself can be any suitable video display panel, such as a plasma screen, an LED wall, an LCD screen, a monitor, a TV, a tablet, a mobile phone, etc. A variety of sizes can be used. When an image (e.g., stationary or moving) is shown on the video panel display 270, such as a person or object within an otherwise black (or other stable dark color) background, that image is then reflected onto the transparent screen (e.g., tensioned foil or otherwise), appearing to the viewer (shown as the stick figure) in a manner according to Pepper's Ghost Illusion. However, different from the original Pepper's Ghost Illusions using live actors/objects, and different from projector-based holographic systems, the use of video panel displays reduces or eliminates the “light beam” effect through atmosphere (e.g., fog), allowing for a clearer and un-tainted visual effect of the holographic projection. (Note that various diffusion layers may be used to reduce visual effects created by using video panel displays, such as the Moiré effect.) Also, using a video panel display 270 may help hide projector apparatus, and may reduce the overall size of the holographic system.

Additionally, some video panels such as LED walls are able to generate a much brighter image than projectors are able to generate thus allowing the Pepper's Ghost Illusion to remain effective even in bright lighting conditions (which generally degrade the image quality). The brighter image generated from an LED wall also allows for objects behind the foil to be more well lit than they can be when using projection.

In addition, by displaying an image of an object or person with a black background on the light source, it is reflected onto the transparent flat surface so it looks like the object or person is floating or standing on its own. In accordance with typical Pepper's Ghost Illusion techniques, a stage or background can be put behind and/or in front of the transparent film so it looks like the object or person is standing on the stage, and other objects or even people can also be on either side of the transparent film.

In certain embodiments, to alleviate the large space requirement in setting up a Pepper's Ghost display (e.g., to display a realistic holographic projection, a large amount of depth is typically needed behind the transparent screen), an optical illusion background may be placed behind the transparent screen in order to create the illusion of depth behind the screen (producing a depth perception or “perspective” that gives a greater appearance of depth or distance behind a holographic projection).

In general, holographic projections may be used for a variety of reasons, such as entertainment, demonstration, retail, advertising, visualization, video special effects, and so on. The holographic images may be produced by computers that are local to the projectors or video panels, or else may be generated remotely and streamed or otherwise forwarded to local computers.

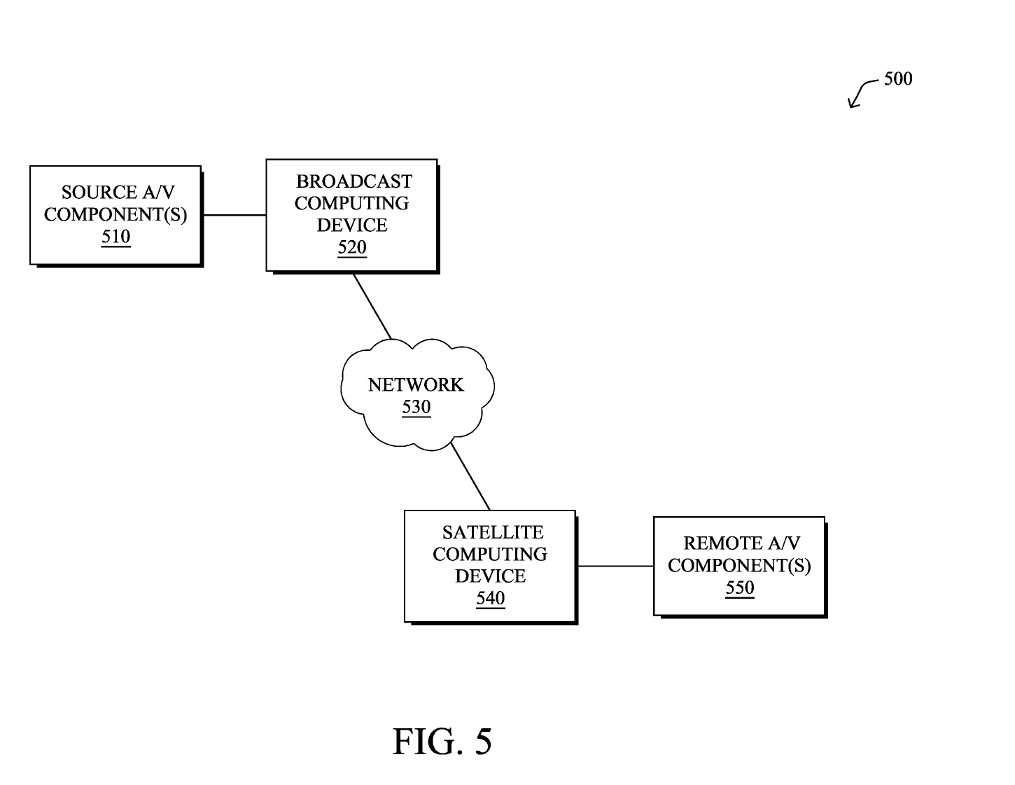

As an example of remote streaming, a video image may be streamed and projected to a remote location. For instance, the system herein may holographically live-stream real cashiers for interaction with real people, or else may stream images of products that are stored on remote servers, rather than locally. FIG. 5 illustrates an example simplified holographic projection system (e.g., communication network), where the network 500 comprises one or more source A/V components 510 (capturing live images or storing product images or videos), one or more “broadcast” computing devices 520 (e.g., a local computing device), a communication network 530 (e.g., the public Internet or other communication medium, such as private networks), one or more “satellite” computing devices 540 (e.g., a remote computing device), and one or more remote A/V components 550.

—Holographic Interactive Retail System—

For the holographic interactive retail system is described herein, any suitable type of holographic image may be used, such as the illustrative Pepper's Ghost Illusion techniques above, and at any applicable location. For instance, in one embodiment, the holographic retail system described herein may be used in a retail setting, such as a storefront window (inside or outside the window), as a standalone kiosk system (e.g., in the hallway of a shopping mall or at a busy street corner), and so on. In this manner, the customers can interact with a holographic sales system (e.g., a holographic clerk or other interactive sales system), and may do so during open hours or after-hours when closed, selecting holographic products via gesture control and purchasing them for shipment to the customer from warehouses.

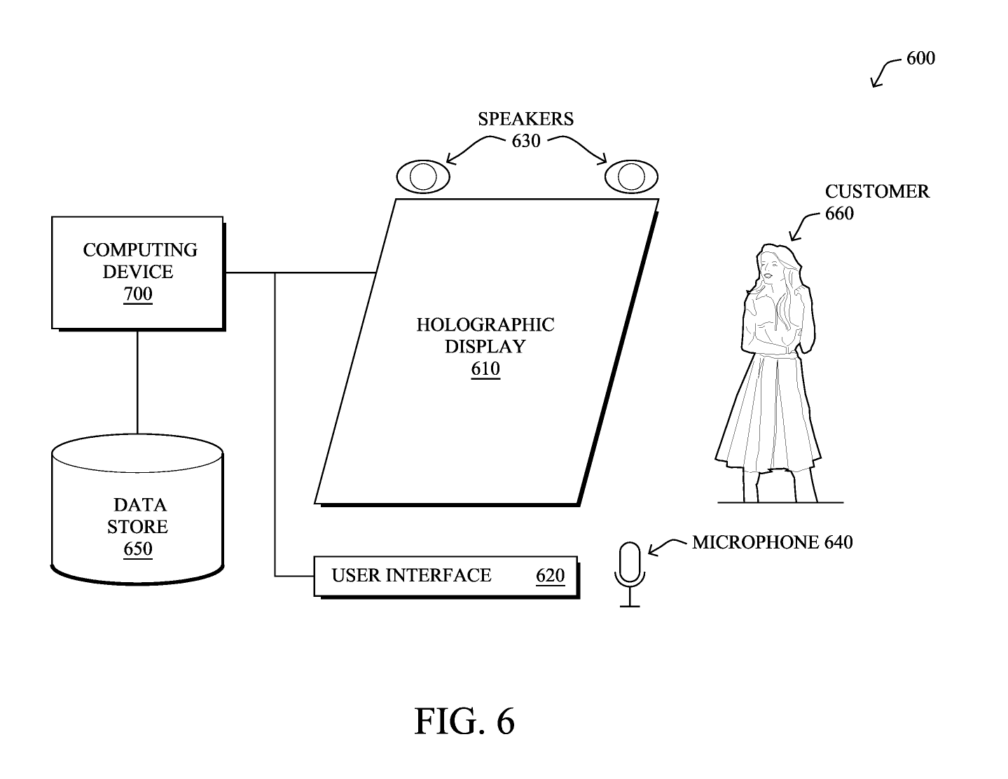

FIG. 6 illustrates an example interactive retail system, where the system 600, which may be behind a storefront window or open to the public, comprises a holographic display 610, a user interface 620, and a computing device 700. The holographic display 610 may be based on any holographic image generation technique, such as those described above. Other peripheral devices, such as speakers 630, microphone 640, payment kiosk, etc., may also be included in the system 600. In general, a data store 650 may be local to the computing device 700, or else may be remotely located on one or more servers across a communication network. Lastly, a user or customer 660 interacts with the system 600 as described below.

In accordance with one or more aspects of the present invention, the user interface 620 is configured to provide an interactive user experience greater than what's available from current systems. For instance, in an illustrative embodiment, the user interface is capable of detecting a customer's motions for gesture control, as well as other advanced features such as facial expression detection, depth-based image capture, dynamic customer/product overlays, etc., as described below. All of these systems, as detailed herein, allow customers to walk up to the system 600, search for products, learn about products, and ultimately buy products.

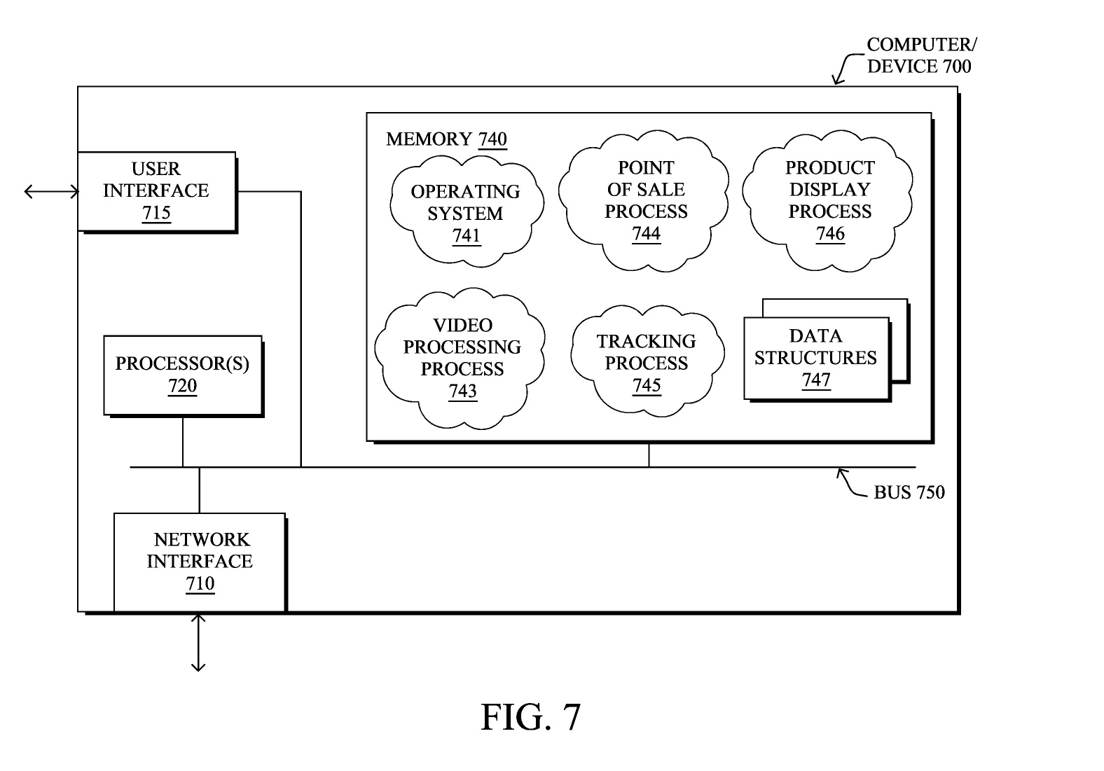

FIG. 7 illustrates an example simplified block diagram of the computing device 700 that may be used in conjunction with the interactive holographic retail system 600 herein. In particular, the simplified device 700 may comprise one or more network interfaces 710 (e.g., wired, wireless, etc.), a user interface 715 (to interact with holographic display 610 and user interface 620), at least one processor 720, and a memory 740 interconnected by a system bus 750. The memory 740 comprises a plurality of storage locations that are addressable by the processor 720 for storing software programs and data structures associated with the embodiments described herein. The processor 720 may comprise hardware elements or hardware logic adapted to execute the software programs and manipulate the data structures 747. Note that the inputs and outputs shown on device 700 are illustrative, and any number and type of inputs and outputs may be used to receive and transmit associated data, including more or fewer than those shown in FIG. 7 (e.g., where user interface 715 is separate inputs/outputs for the holographic display 610 and the user interface 620, etc.).

An operating system 741, portions of which are resident in memory 740 and executed by the processor, may be used to functionally organize the device by invoking operations in support of software processes and/or services executing on the device. These software processes and/or services may comprise, illustratively, such processes as a video processing process 743, point-of-sale service process 744, a customer tracking process 745, a product display process 746, among others. In terms of functionality, the processes may be configured to contain computer executable instructions executed by the processor 720 to perform various features of the system described herein, either singly or in various combinations. It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes and/or applications.

In accordance with one or more embodiments of the present invention, various gesture detection techniques may be used in conjunction with the system 600. For example, computing applications such as computer games and multimedia applications have evolved from using controllers, remotes, keyboards, mice, or the like to allow users to manipulate game characters or other aspects of an application. In particular, computer games and multimedia applications have begun employing cameras and software gesture recognition engines to provide a natural user interface (“NUI”). With NUI, raw joint data and user gestures are detected, interpreted, and used to control characters or other aspects of an application.

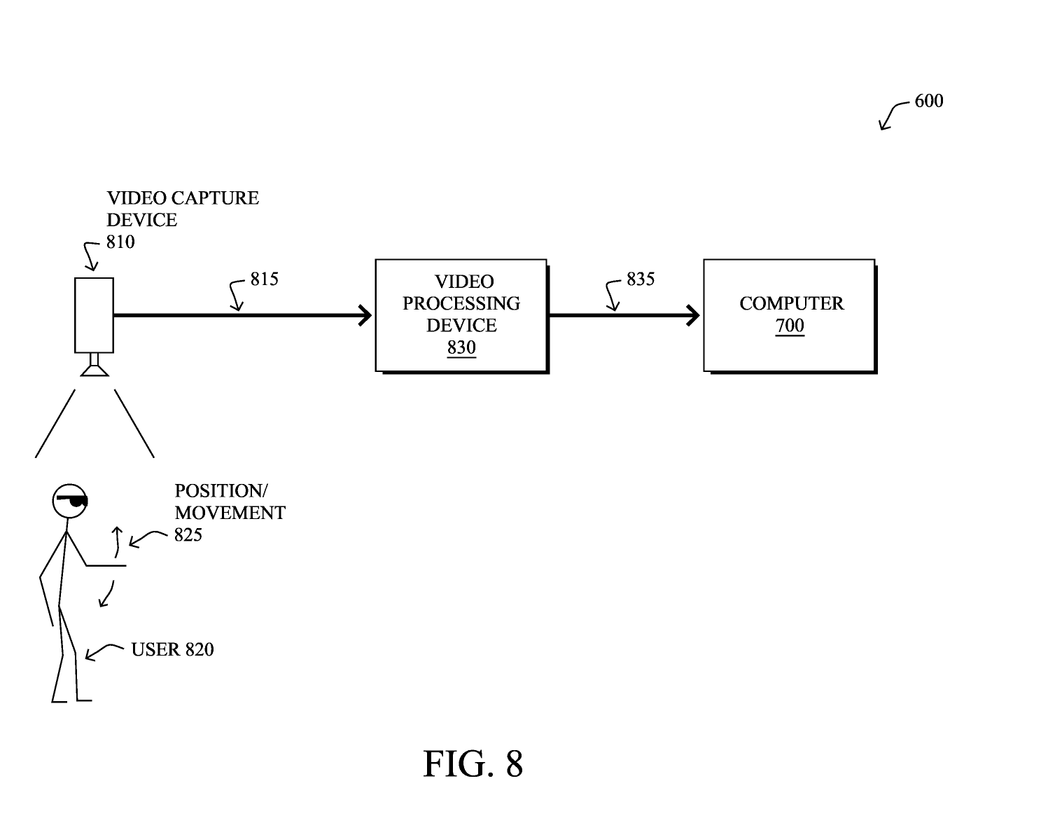

FIG. 8 illustrates a simplified example of video input and gesture control system in accordance with one or more embodiments of the present invention. In particular, as shown in the system 800, a video capture device 810 is configured to capture video images of one or more objects, particularly including one or more users 820 (e.g., a customer 660) that may have an associated position and/or movement 825. The video capture device 810 relays the captured video data 815, which may comprise color information, position/location information (e.g., depth information), etc., to a video processing system 830. At the video processing system 830, various body tracking and/or skeletal tracking algorithms can be used to detect the locations of various tracking points (e.g., bones, joints, etc.) of the user 820, which is then sent as tracked/skeletal data 835 to the computer 700 of system 600 above.

As an example, in accordance with one or more embodiments of the present invention, the hardware and software system used for the video capture device 810 and/or the video processing system 830 may be illustratively based on a KINECT™ system available from MICROSOFT™, and as such, certain terms used herein may be related to such a specific implementation. However, it should be noted that the techniques herein are not limited to a KINECT™ system, and other suitable video capture, skeletal tracking, and processing systems may be equally used with the embodiments described herein. For instance, while the KINECT™ system is configured to detect and relay video and depth information (e.g., a red-green-blue (RGB) camera with infrared (IR) detection capabilities), and also to detect various tracking points based on skeletal tracking algorithms, other suitable arrangements, such as an RGB camera in combination with other ways to detect user input may also be used in accordance with various techniques herein.

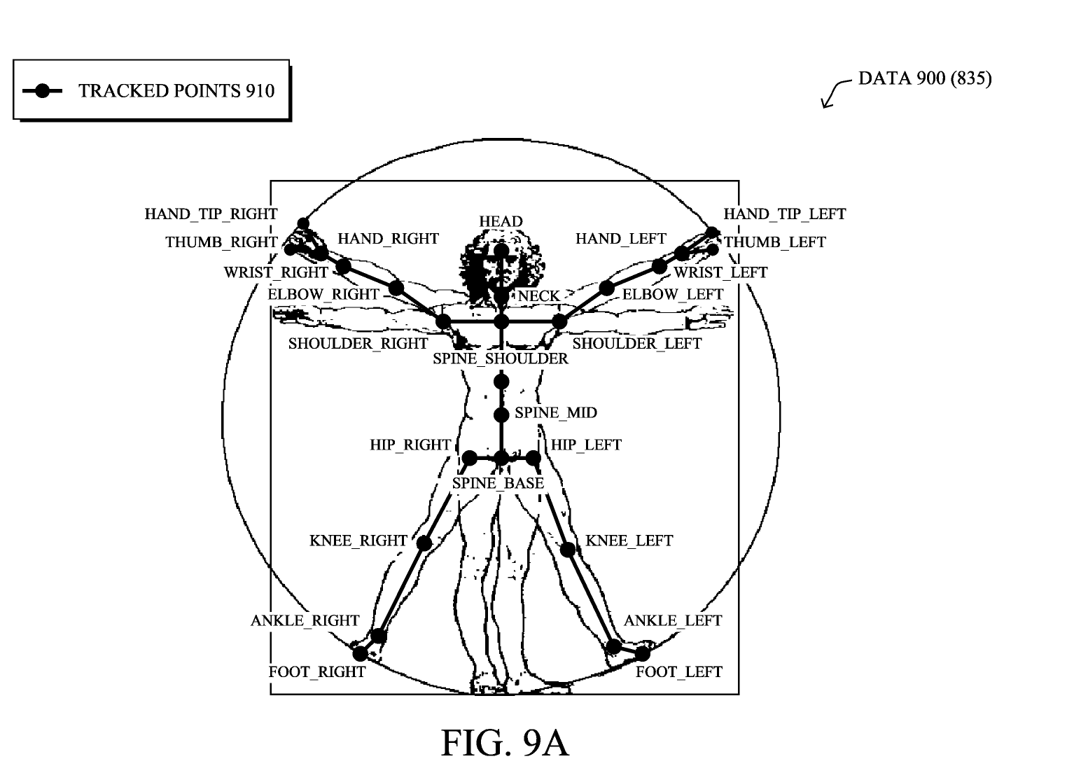

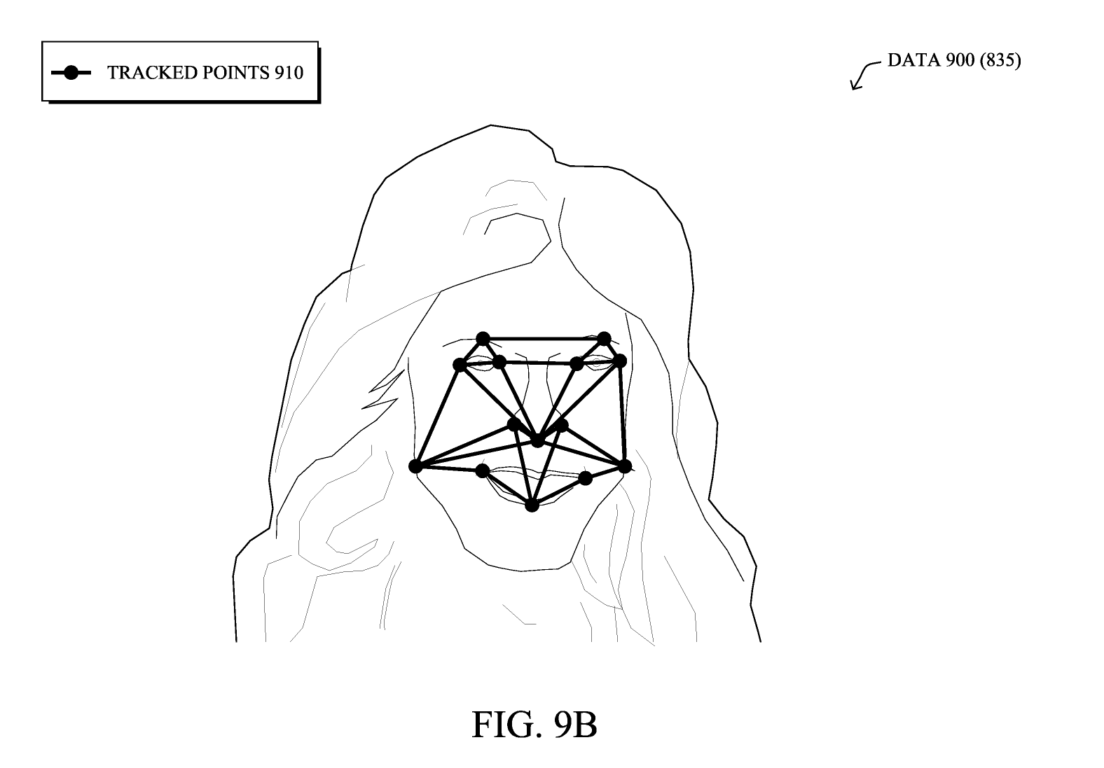

Though various video processing systems 830 can track any number of points, the illustrative system herein (e.g., the KINECT™ system) is able to track twenty-five body joints and fourteen facial joints, as shown in FIGS. 9A and 9B, respectively. In particular, as shown in FIG. 9A, data 900 (video data 815) may result in various tracked points 910 comprising primary body locations (e.g., bones/joints/etc.), such as, e.g., head, neck, spine_shoulder, hip_right, hip_left, etc. Conversely, as shown in FIG. 9B, tracked points 910 may also or alternatively comprise primary facial expression points, such as eye positions, nose positions, eyebrow positions, and so on. Again, more or fewer points may be tracked, and those shown herein (and the illustrative KINECT™ system) are merely an illustrative example.

Notably, the specific technique used to track points 910 is outside the scope of the present disclosure, and any suitable technique may be used to provide the tracked/skeletal data 835 from the video processing system 830. In particular, while FIGS. 9A and 9B illustrate point-based tracking, other devices can be used with the techniques herein that are specifically based on skeletal tracking, which can reduce the number of points needed to be tracked, and thus potentially the amount of processing power needed.

In accordance with one or more embodiments described herein, the gesture recognition system above can be used to allow a customer 660 to control various features of the retail system 600, such as by selecting various options, “swiping” through products, selecting products, and so on. For instance, based on detecting a user's arm movement, various inputs can be used to control the images displayed on the holographic display 610.

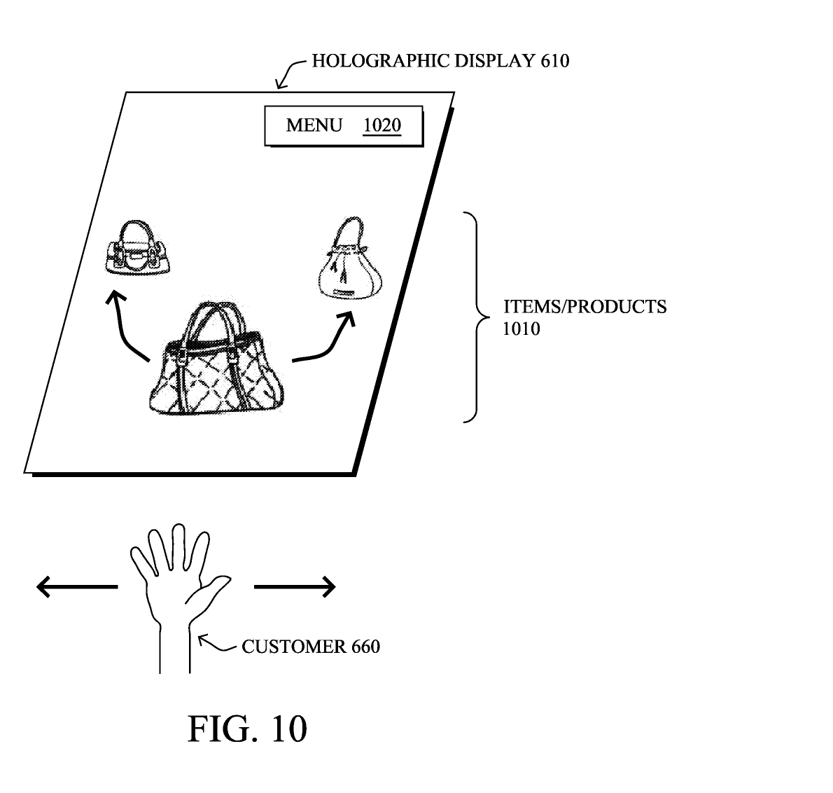

FIG. 10 illustrates an example of gesture control in accordance with one or more embodiments herein. For example, a user 660 may move his or her arm in a side-to-side “swiping” motion to browse through a series of items 1010 (e.g., products), where the products are displayed on the holographic display 610. Different motions might trigger different actions on the display, such as swiping up to save an item, down to remove an item, a circling motion to show other views or pan around the item, and so on. Different parts of the display may show different menu options 1020, such as to “add to cart”, “search”, or other types of selections typically available during online shopping. In addition, in one embodiment one such menu option 1020 might be to “learn more” about a product, in which case, a new image or video might appear about the product, such as seeing a video on how to use a product, displays of what other clothes might match a particular product, a video of someone wearing the product, etc. Also, during the browsing, various “pop-ups” could appear, such as coupons for products that the customer 660 “grabs” with his or her hand based on the gesture recognition.

In accordance with still another embodiment of the present invention, tracked facial features may be used by the retail system 600 in advantageous manners. For instance, facial expressions can often tell a lot about a customer's opinions while looking at products. For example, people may scrunch their noses, shake their heads, or even stick out their tongues at products they don't like. Similarly, other expressions such as smiles, head nods, etc. may show interest in a given product. By using these visual facial cues, as tracked above or else as tracked by other facial recognition software, not only can valuable feedback be stored for marketing purposes, but the customer's actual experience can be enhanced. For instance, a learning-machine algorithm could be implemented, where a customer's “likes” and “dislikes” can be guided not only by explicit selection, but by facial expression or even body language. For example, if the computer 700 determines that the customer continually gives a “no” face to a certain style of clothing, then the list of options presented to the customer may be adjusted to remove any further products similar to those styles. Conversely, if a user nods his or her head to certain products when they appear, then more of those products could be presented. Other algorithms and confirmations may be used in addition to facial recognition, such as time spent on a particular product, speed at which the “swipe” occurred, and so on, and the learning machine techniques herein are not meant to be limited to merely those options discussed herein.

Notably, in many retail situations, more than one person might be present at a time at or near the interactive holographic retail system 600. According to one or more embodiments herein, therefore, depth-based user tracking allows for selecting a particular user from a given location that is located within a certain distance from a sensor/camera to control the system. For example, when many people are gathered around a system 600 or simply walking by, it can be difficult to select one user to control the system, and further so to remain focused on that one user. Accordingly, various techniques are described (e.g., depth keying) to set an “active” depth space/range.

In particular, the techniques herein may visually capture a person and/or object from a video scene based on depth, and isolate the captured portion of the scene from the background in real-time. For example, as described in commonly owned, co-pending U.S. patent application Ser. No. 14/285,905, entitled “Depth Key Compositing for Video and Holographic Projection” filed on May 23, 2014 by Crowder et al. (the contents of which incorporated by reference herein in its entirety), special depth-based camera arrangements may be used to isolate objects from captured visual images.

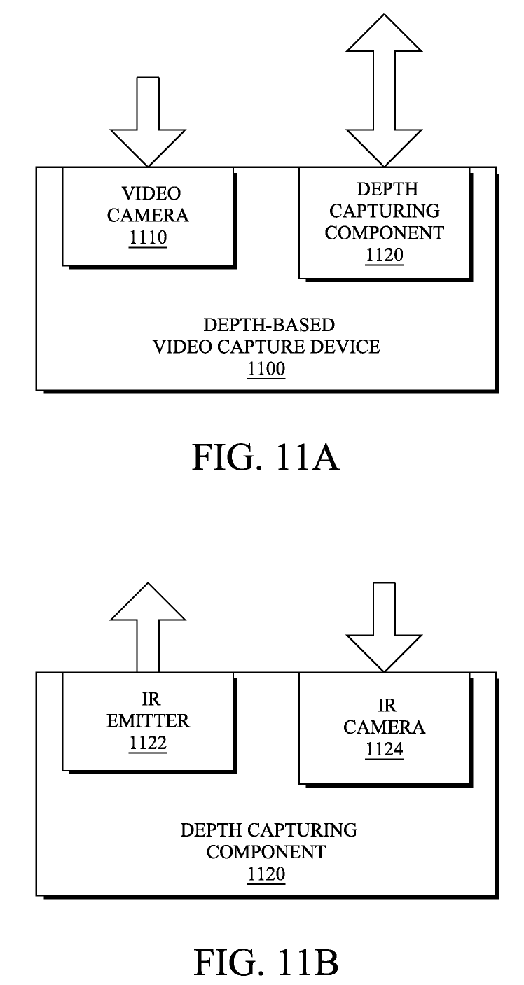

In order to accomplish depth-based user limiting in this manner, a video capture device used herein may comprise a camera that is capable of detecting object distance. One such example camera that is commercially available is the KINECT™ camera mentioned above, though others are equally suitable. Illustratively, as shown in FIG. 11A, a depth-based video capture device 1100 may comprise two primary components, namely a video camera 1110 and a depth-capturing component 1120. For example, the video camera 1110 may comprise a “red, green, blue” (RGB) camera (also called a color video graphics array (VGA) camera), and may be any suitable rate (e.g., 30 or 60 frames per second (fps)) and any suitable resolution (e.g., 640×480 or greater, such as “high definition” resolutions, e.g., 1080p, 4K, etc.).

The depth capturing component 1120 may comprise two separate lenses, as illustrated in FIG. 11B, such as an infrared (IR) emitter 1122 to bathe the capture space in IR light, and an IR camera 1124 that receives the IR light from the IR emitter as it is reflected off of the objects within the capture space. For instance, the brighter the detected IR light, the closer the object is to the camera. One specific example of an IR camera is a monochrome CMOS (complimentary metal-oxide semiconductor) sensor. Notably, the IR camera 1124 (or depth capturing component 1120, generally) may, though need not, have the same frame rate and resolution as the video camera 1110 (e.g., 30 fps and 640×480 resolution). Note also that while the video camera 1110 and depth capturing component 1120 are shown as an integrated device, the two components may be separately located (including separately locating the illustrative IR emitter 1122 and IR camera 1124), so long as there is sufficient calibration to collaboratively determine portions of the video image based on depth between the separately located components.

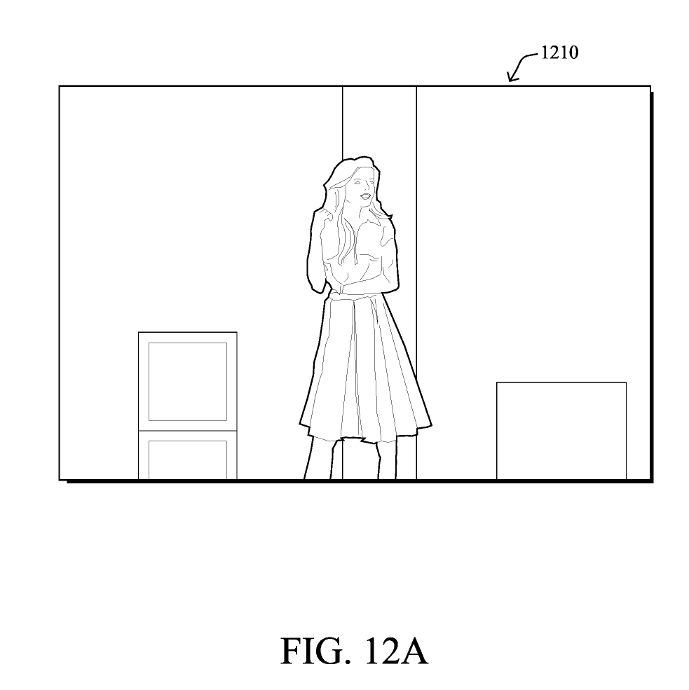

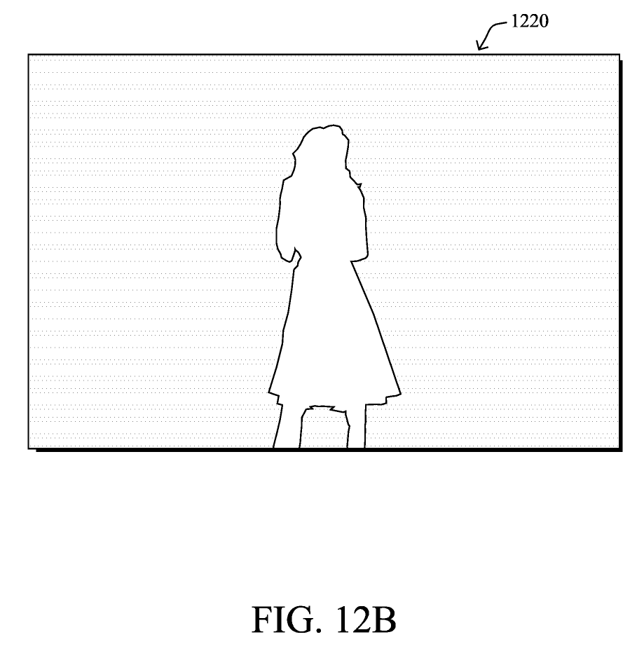

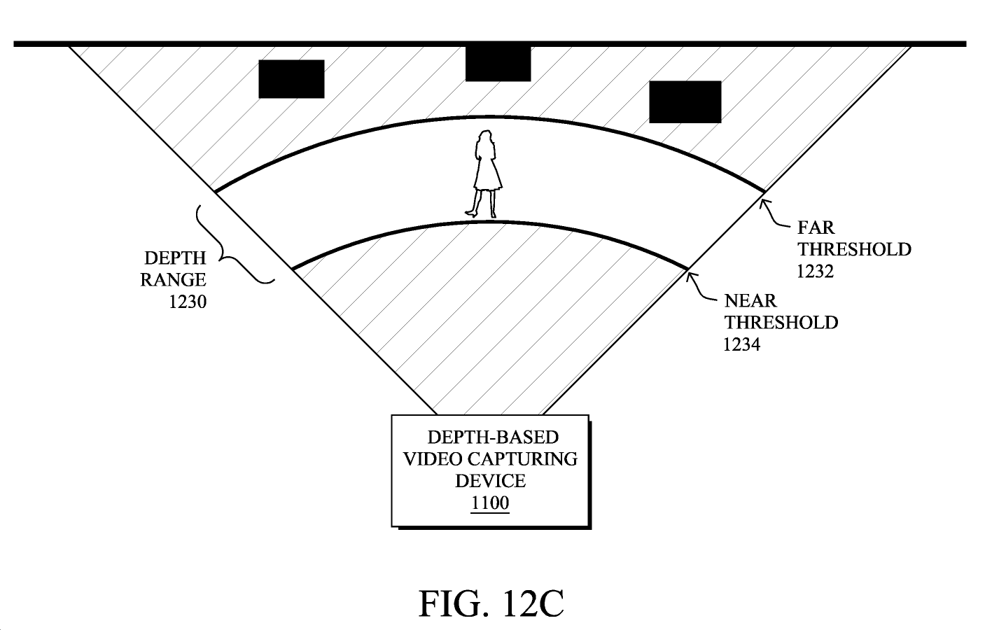

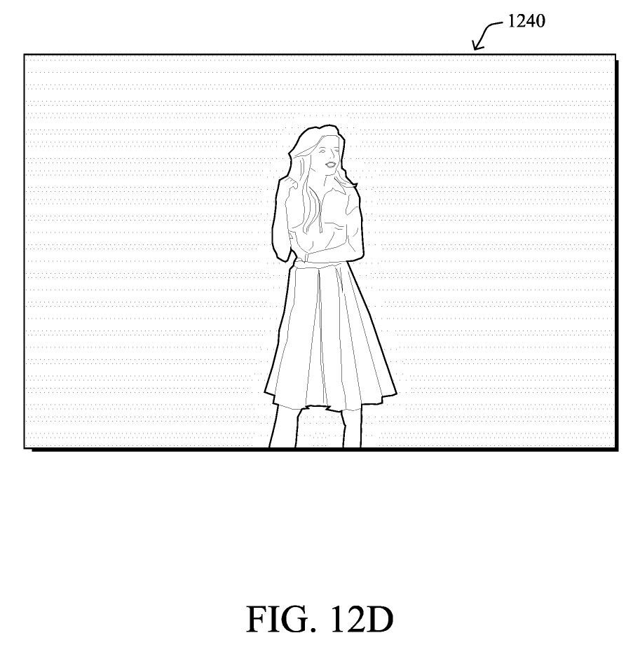

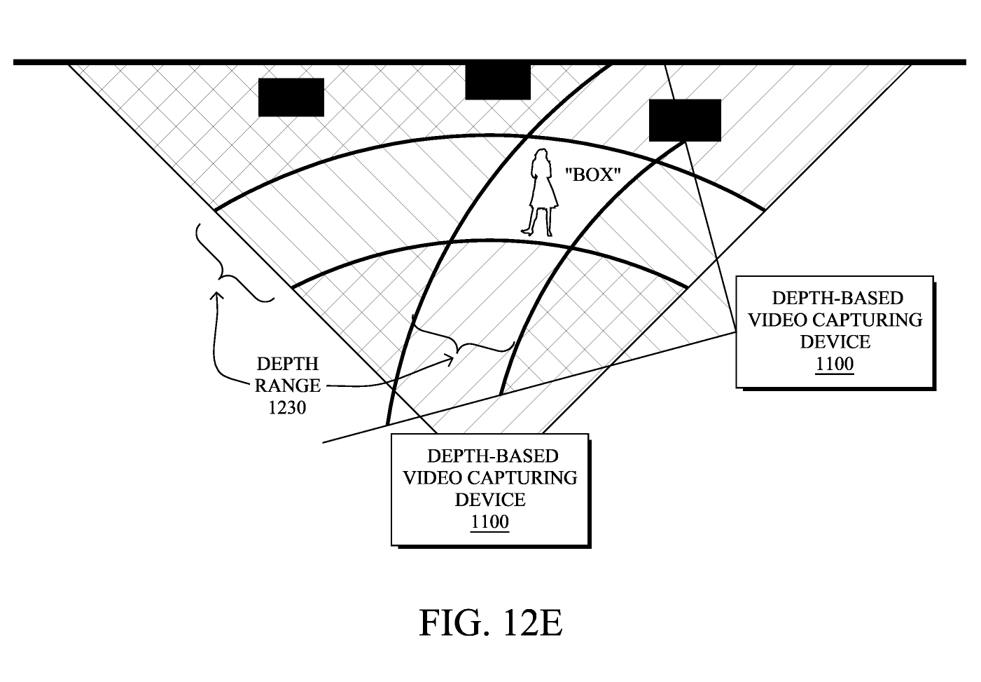

Based on inputting the images from the camera 1100 into the video processing system 830, a corresponding depth differentiating component of the video processing system enables setting/defining a desired depth range (e.g., manually via user interface or dynamically by the process itself) using the captured depth information (e.g., IR information). For example, FIG. 12A illustrates an example source image 1210 that may be captured by the video camera 1110. Conversely, FIG. 12B illustrates an example depth-based image 1220 that may be captured by the depth capturing component 1120, such as the IR image captured by the IR camera 1124 based on reflected IR light from the IR emitter 1122. In particular, the image 1220 in FIG. 12B may be limited (manually or dynamically) to only show the desired depth range of a given subject (person, object, etc.), such as based on the intensity of the IR reflection off the objects.

According to one or more embodiments herein, the depth range selected to produce the image 1220 in FIG. 12B may be adjusted on-the-fly (e.g., manually by a technician or dynamically based on object detection technology) in order to control what can be “seen” by the camera. For instance, the techniques herein thus enable object tracking during live events, such as individual customers moving around. For example, as shown in FIG. 12C, an aerial view of the illustrative scene is shown, where the desired depth range 1230 may be set by a “near” depth threshold 1234 and a “far” depth threshold 1232. Other techniques may be used, such as defining a center depth (distance from camera) and then a depth of the distance captured surrounding that center depth, or defining a near or far depth threshold and then a further or nearer depth (in relation to the near or far depth threshold), respectively. This can also be combined with other body tracking algorithms (e.g., as described below).

By then overlaying the depth information (IR camera information) of image 1220 in FIG. 12B with the video image 1210 from FIG. 12A, the techniques herein “cut out” anything that is not within a desired depth range, thus allowing the camera to “see” (display) whatever is within the set range, as illustrated by the resultant image 1240 in FIG. 12D. In this manner, the background image may be removed, isolating the desired person/object (customer 660) from the remainder of the visual scene captured by the video camera 1110. (Note that foreground images may also thus be removed.)

Note also that as shown in FIG. 12E, multiple depth sensors could be used to further define the “active” region, e.g., placing a depth sensor on the side of the subject area so that a more clearly-defined “box” could be defined as the “active” area (i.e., the intersection of depth ranges between the two sensors).

By maintaining a consistent depth range 1230, a mobile object or person may enter or exit the depth range, thus appearing and disappearing from view. At the same time, however, by allowing for the dynamic and real-time adjustment of the depth range as mentioned above, a mobile object or person may be “tracked” as it moves in order to maintain within the depth range, accordingly.

Notably, in one embodiment as mentioned above, body tracking algorithms, such as skeletal tracking algorithms, may be utilized to track a person's depth as the person moves around the field of view of the cameras. For example, in one embodiment, the perspective (relative size) of the skeletally tracked individual(s) (once focused on that particular individual within the desired depth range) may result in corresponding changes to the depth range: for instance, a decrease in size implies movement away from the camera, and thus a corresponding increase in focus depth, while an increase in size implies movement toward the camera, and thus a corresponding decrease in focus depth. Other skeletal techniques may also be used, such as simply increasing or decreasing the depth (e.g., scanning the focus depth toward or away from the camera) or by increasing the overall size of the depth range (e.g., moving one or both of the near and far depth thresholds in a manner that widens the depth range).

In an alternative embodiment, if body tracking is enabled, the set depth range may remain the same, but a person's body that leaves that depth range may still be tracked, and isolated from the remaining scene outside of the depth range. For instance, body tracking algorithms may be used to ensure a person remains “captured” even if they step out of the specified depth range, allowing for certain objects to be left in the depth range for capture while a person has the freedom to move out of the depth range and still be captured. As an example, assume in FIG. 12C that there was an object, such as a chair, within the specified depth range 1230. If the person were to step out of the depth range 1230 while body tracking in this embodiment was enabled, the chair would remain in the isolated portion of the scene, as well as the person's body, regardless of where he or she moved within the captured image space. On the contrary, in the embodiment above where the body tracking adjusts the depth range, the chair may come into “view” of the dynamically adjusted depth range 1230 and become part of the isolated image only when the person moves to a depth corresponding to the chair.

Accordingly, with either type of body tracking enabled, a customer that moves around can be kept within control of the system, without having to remain stationary. For example, once the depth range is set, if body tracking is enabled and a person moves out of the depth range, they will still be tracked and in control of the system, whether by dynamically adjusting the depth range, or else by specifically following the person's body throughout the captured scene.

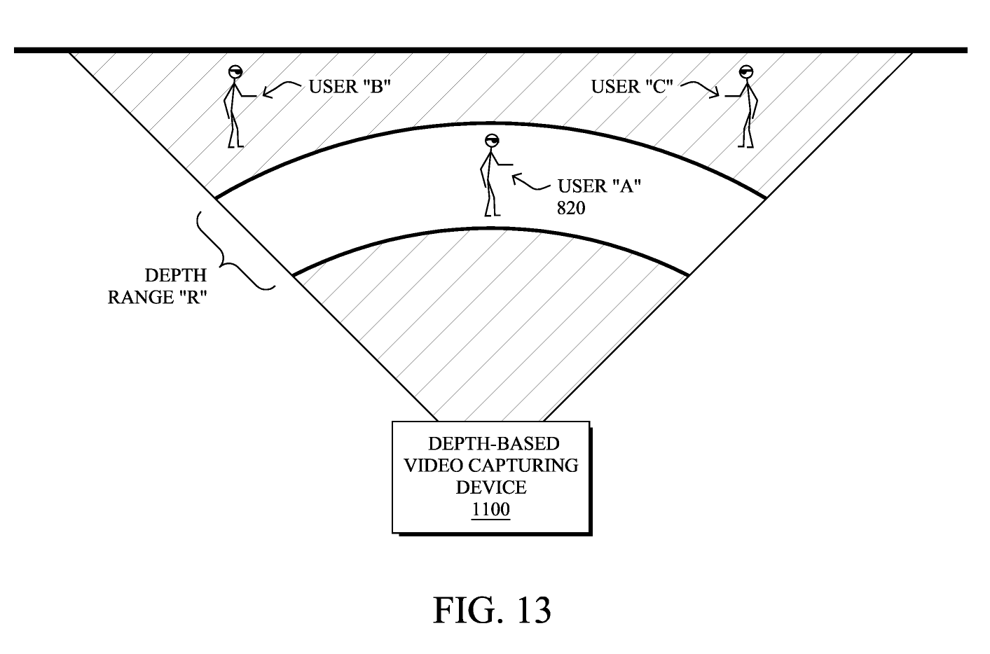

In accordance with the embodiments of the present invention, therefore, and as illustrated in FIG. 13, depth-based user tracking allows for selecting a particular user (e.g., “A”) from a given location that is located within a certain distance (depth range “R”) from a sensor/camera to control the system, and not any other users (e.g., “B”, “C”, etc.) not within that range. In this manner, user tracking algorithms may function with reduced “noise” from other potential user candidates to control the system 600. In addition, use of the depth range allows for the system to “activate” only when a user is located within the range “R” (e.g., 2-10 feet from the camera/sensor, and optionally only when looking at the system 600), allowing the system to remain idle until a user is located nearby.

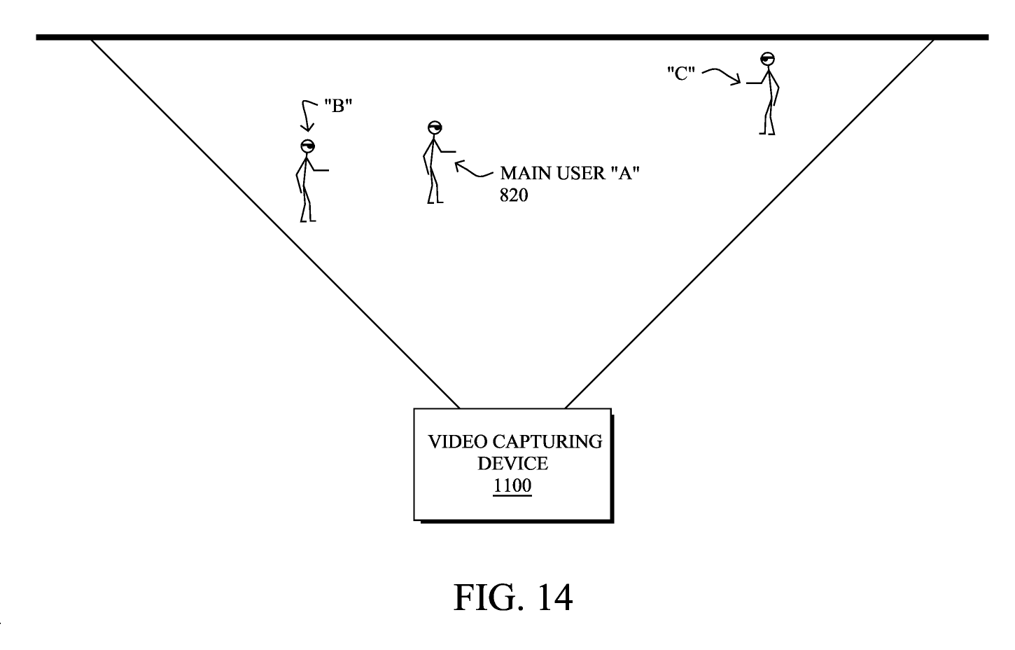

In an additional embodiment, once a user is selected, that user remains as the selected user in control of the system 600, while other users may still be tracked in the background (e.g., within the active depth space) until the selected user is no longer tracked (e.g., steps out of view of the sensor). At this time, a subsequent user may be selected to control the system, and any previous selections may (though need not) be removed (e.g., starting over as a fresh user, or else continuing where the previous user left off). For example, as shown in FIG. 14, once a user steps in front of the camera 1110 and is recognized/tracked, they can be given a UserId (e.g., by the video processing system 830) that is not lost until that person is no longer tracked. Using this, the techniques herein define a “Main User” variable which is set once the first person is tracked (e.g., user “A”), and is only changed when that person leaves/is untracked. At this point the “Main User” switches to the next tracked person (UserId's are in chronological order from first to last tracked), if any (e.g., users “B” or “C”), or waits until the next person is tracked. Generally, this technique, in addition to or as an alternative to the depth-based technique above, prevents tracking interruption when others walk by the primary tracked user.

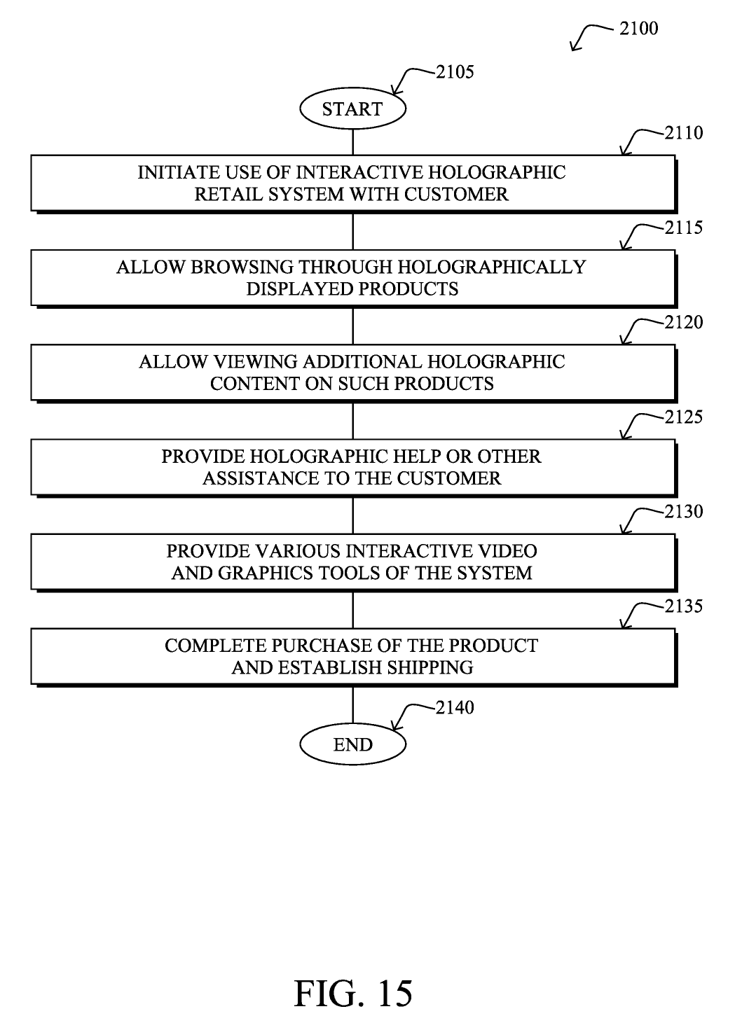

FIG. 15 illustrates an example simplified procedure for depth-based user tracking for interactive holographic retail system control in accordance with one or more embodiments described herein. The simplified procedure 1500 may start at step 1505, and continues to step 1510, where a depth range is defined in order to detect a customer 660 in step 1515. (Note that the order of these steps may be specifically reversed: that is, detecting a customer, and then defining the depth range based on the detected customer). In step 1520, the customer is tracked within the depth range, allowing for users outside of the depth range to be ignored in step 1525. Also, as noted above, optionally in step 1530, sequential user tracking may also be used to further prevent tracking interruptions when other users enter the scene (e.g., the depth range or otherwise). The simplified procedure 1500 ends in step 1535, notably with the option to continue any of the steps above (e.g., detecting users, adjusting depth ranges, tracking users, etc.).

In still another embodiment of the system herein, a “virtual cashier” or customer representative can be displayed as a holographic projection, and may enhance the customer's retail experience, particularly where a local cashier or customer representative is not otherwise available. For instance, in one embodiment, the holographic display may be used to show a video stream of a real customer representative, who may be located remotely (e.g., at a call center). For example, a customer 660 may be allowed to select a “chat now” or “need help” option, bringing up the option to talk to a live representative, whose image would appear as the holographic projection 610. Alternatively, a computer generated representative may take the place of a real person, and may be completely automated (e.g., visual and verbal response based on computer responses to inquiry and/or action), or may be animated based on a live (remote) representative (e.g., showing an image of a different person that is controlled by a real representative).

In particular, in computing, an “avatar” is the graphical representation of a user (or the user's alter ego or other character). Avatars may generally take either a two-dimensional (2D) form or three-dimensional (3D) form, and typically have been used as animated characters in computer games or other virtual worlds (e.g., in addition to merely static images representing a user in an Internet forum). To control an avatar or other computer-animated model (where, notably, the term “avatar” is used herein to represent humanoid and non-humanoid computer-animated objects that may be controlled by a user), a user input system converts user action into avatar movement.

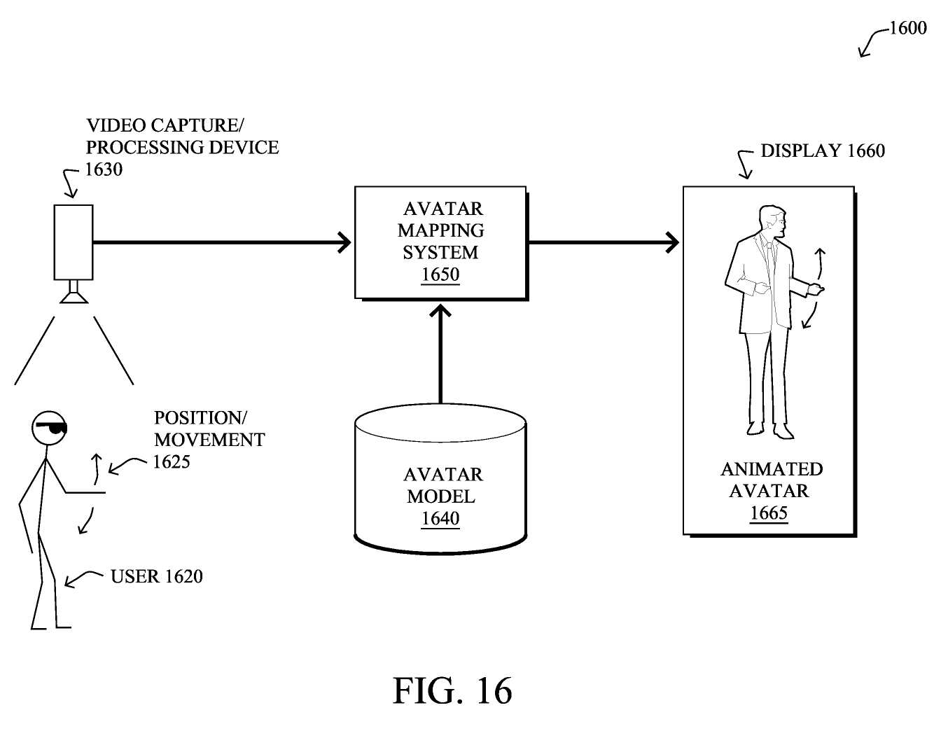

FIG. 16 illustrates a simplified example of an avatar control system. In particular, as shown in the system 1600, a video capture/processing device 1610 is configured to capture video images of one or more objects, particularly including one or more users 1620 that may have an associated position and/or movement 1625. The captured video data may comprise color information, position/location information (e.g., depth information), which can be processed by various body tracking and/or skeletal tracking algorithms to detect the locations of various tracking points (e.g., bones, joints, etc.) of the user 1620. An avatar mapping system 1650 may be populated with an avatar model 1640, such that through various mapping algorithms, the avatar mapping system is able to animate an avatar 1665 on a display 1660 as controlled by the user 1620. Illustratively, in accordance with the techniques herein the display 1660 may comprise a holographic projection of the model animated avatar 1665 (e.g., holographic projection 610 of the interactive holographic retail system 600), allowing an individual to interactively control a holographic projection of a character.

In this manner, the displayed holographic image 610 may be able to show not only the products and customer representatives, but any animated character, and particularly ones that can be controlled by a remote user. For instance, in addition to customer representatives, hidden actors may be used to control avatars of celebrities, fictional characters, cartoon characters, anthropomorphized objects, etc. For example, with the techniques here, a person shopping at a store specializing in merchandise for children's animated characters can actually get help from an animated character through the holographic retail system herein.

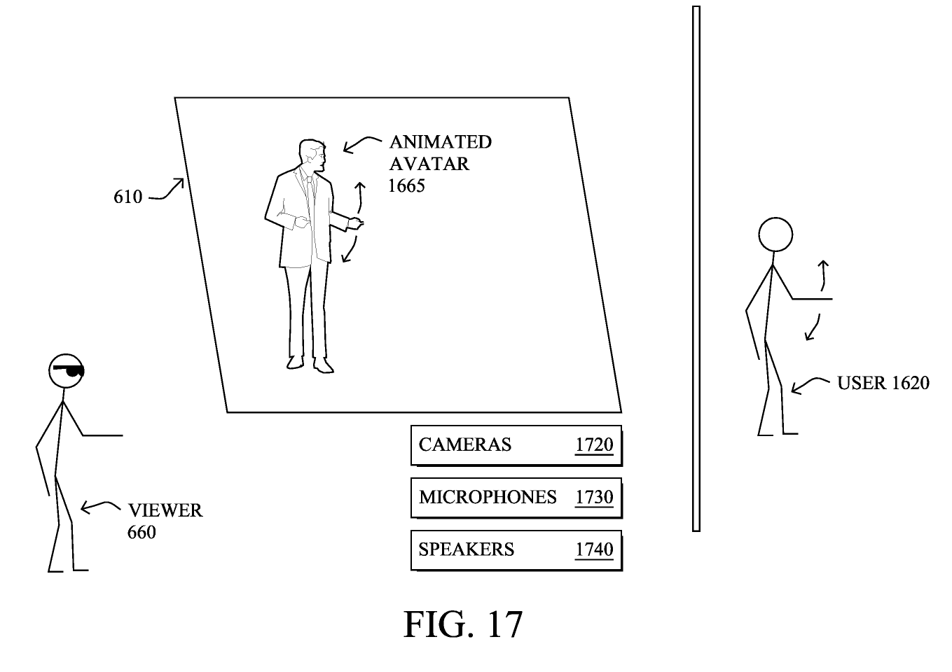

An example of this concept is illustrated in FIG. 17, where a customer 660 can interact with a controlled avatar 1665 that may be controlled by a user 1620, either off to the side (e.g., a backroom of a store) or in a remote location (e.g., a remote call center). For instance, various cameras 1720, microphones 1730, and speakers 1740 (of the retail system 660) may allow the customer 660 to interact with the avatar 1665, enabling the controlling user 1620 to respond to visual and/or audio cues, hold conversations, and so on. Note again that the user 1620 may be replaced by an artificial intelligence engine that is configured to interact with the customer, that is, to respond to various audio or visual responses from the customer, such as playing a pre-recorded voice dialogue and pre-recorded animations.

In accordance with still another embodiment of the present invention, the gesture recognition technology above, skeletal tracking, and avatar control, among other technologies described herein or otherwise known, can be used to provide a number of additional features for the interactive holographic retail system 600 herein. For instance, based on the depth-keying technology above (or chroma-keying, i.e., “green-screening”), an image 1240 of the customer 660 can be obtained in real-time during the retail experience. This image may then be used to display the customer on the holographic display 610, so the customer is now seeing himself or herself. By then using the body tracking or skeletal tracking algorithms mentioned above, products may be placed on or near the holographically displayed customer, so they can see themselves with the product. In other words, the holographic display can be configured to act as a mirror for the user, where products are placed with the user in appropriate positions. In this manner, a customer can easily see what a product will look like on/with the customer, matching particular outfits, checking particular sizes (roughly, of course), and so on.

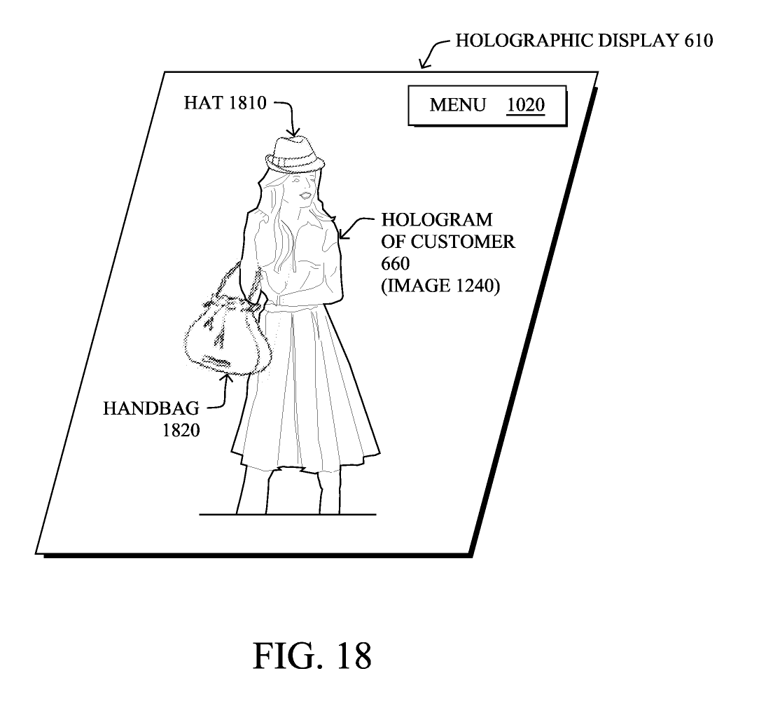

An example of this is shown in FIG. 18, where a customer 660 desires to see herself with a particular hat and handbag. As such, holographic image 610 of the customer may have a hat 1810 placed on her head (based on knowing where the head is using the tracking algorithms), and also a handbag 1820 in her hand (based on knowing where the hand is using the tracking algorithms). While the customer's image 1240 is being captured, and while body/skeletal tracking algorithms are being used, the customer is free to move around, change position, etc., and the hat will stay on her head, and the handbag will stay in her hand. Using advanced tracking algorithms, the customer could also pick up items and place items, (e.g., the hat on the head, the handbag in the hand), may drop items that are no longer desired, etc., simply by using natural hand motions.

Notably, the same techniques may be used for wearing particular articles of clothing, such as displaying a shirt or pants on the customer graphically in front of the customer's image 1240 (holographic display 610). Such clothing articles, for instance, may be sized accordingly for the user, such as by matching an article of clothing to the user's detected body size from image 1240 and/or body/skeletal tracking mentioned above. For instance, the displayed clothing can be generated by stretching a standard image of a product, or else selecting an appropriately sized product, such as small, medium, large, etc.

The images displayed of the products may be 2D or 3D. In particular, a 2D image of a handbag may be displayed in the embodiments above, such that a customer lifting her arm would show the same image of the handbag at a higher hand-held position. However, according to one or more embodiments herein, using a 3D mapping of a product allows the user to have more dynamic control over the product, showing all different sides and angles of a product holographically. For instance, if the customer turns her hand around, while holding the handbag, then the back of the handbag would then be shown. Tipping her head forward would show the top of the hat.

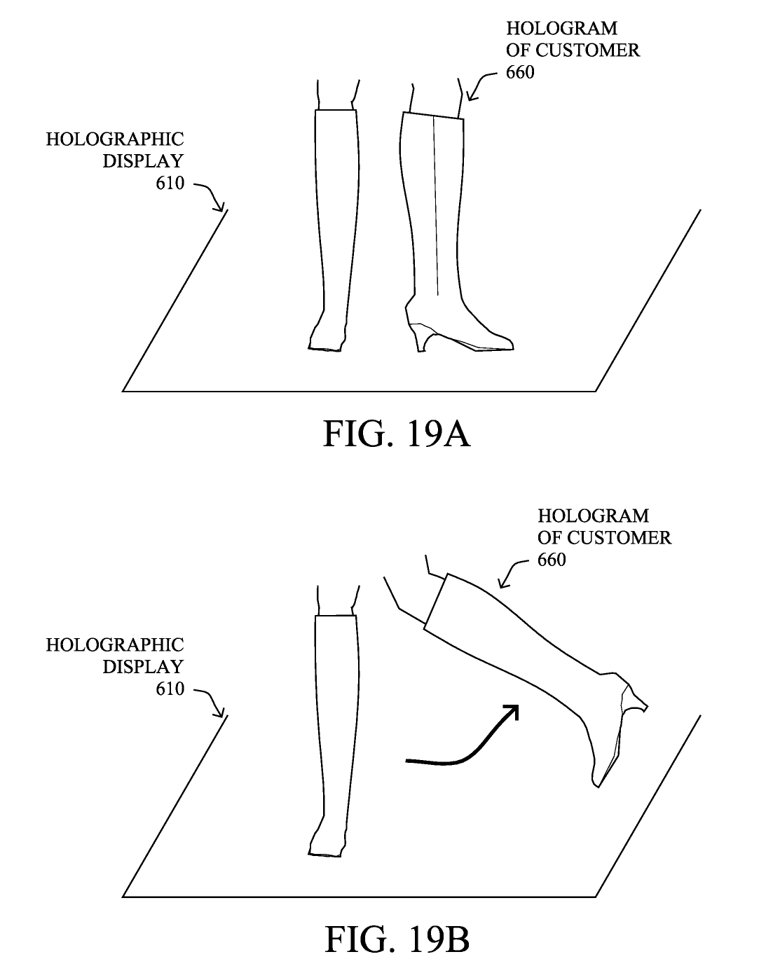

Generally speaking, 3D models of objects can be based on multiple 2D camera angles and angular processing to show the appropriate 2D view of a 3D object. In other embodiments, however, a 3D model may be built of the products or objects, where a graphic designer can “skin” a model, meaning giving the model a mesh and skin weights (as will be understood by those skilled in the art), in order to allow tracking and moving of the model. For instance, while this may be helpful for a hat or a handbag, it is particularly beneficial for clothing, which can be worn on the customer and mapped to the customer's body movements. For example, as shown in FIGS. 19A-19B, when a customer chooses to holographically “wear” a pair of boots, the customer is able to move his or her legs in different angles, and have the boots mapped to that movement to show the different corresponding views.

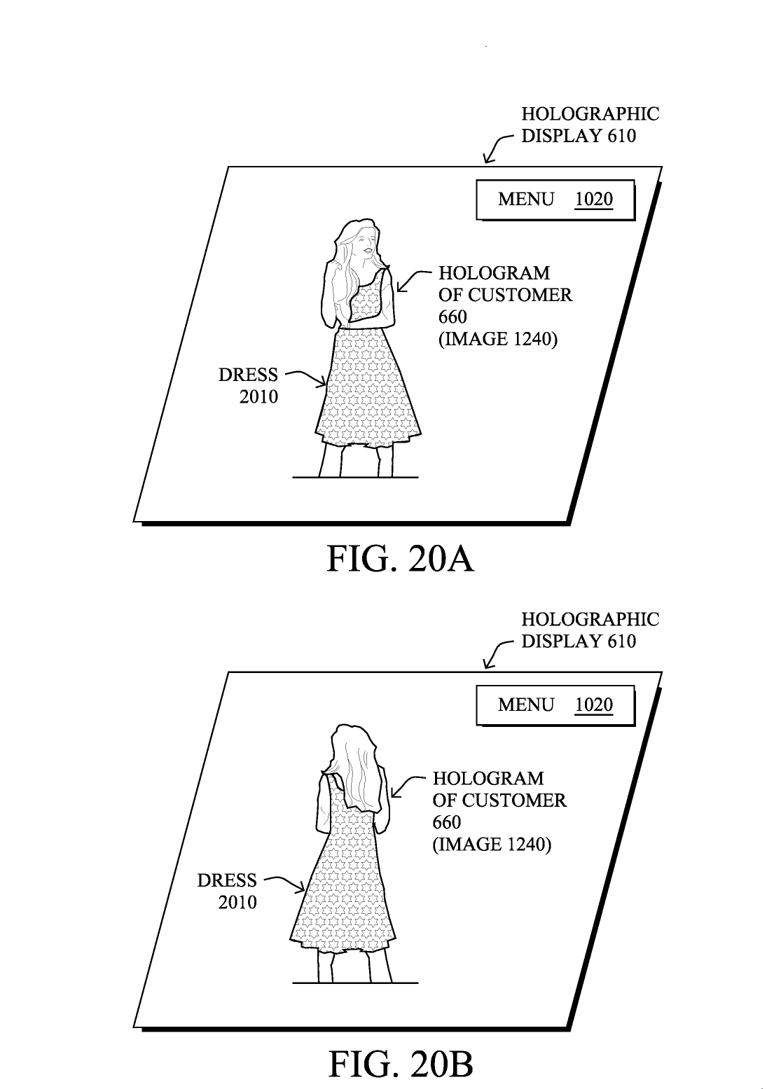

As an enhancement to the above technique, the customer's displayed image 1240, a 2D image, may be replaced by a dynamically mapped 3D avatar representation of the customer. For instance, in this embodiment, rather than merely showing a 2D image 1240, a 3D mesh of the customer may be created and mapped, such that the customer's image not only appears on the holographic display 610, but it can also be clad with various articles of likewise-mapped clothing. For example, assume that a customer desires to see herself in a given dress. As shown in FIG. 20A, an image of the customer 660 can be established to show the customer in the dress 2010. In one embodiment, when the customer turns to the side, as tracked by body/skeletal tracking, the side of the dress 2010 may be shown on top of the side of the user 660, such as turning a full 180 degrees as shown in FIG. 20B. Additionally, in the enhanced embodiment mentioned above, by creating a 3D mapping of the customer (e.g., having the customer turn in a circle in front of the camera for a 3D rendering of actual size or else for a 2D mapping of images to a generic body model), and then cladding the 3D mapped “avatar” of the customer with the desired article of clothing, a more fluid demonstration of “wearing” the article of clothing can be achieved, actually “dressing” the customer's 3D avatar in the article of clothing.

In one embodiment, the 3D model of the products, particularly clothing, can be sized to any customer, stretching and fitting the stored model of the clothing to the body size of the customer. However, in another embodiment, an actual size of the product may be maintained during the mapping, and a customer may then be able to select sizes within a range of available sizes in order to see a virtual “fit” of the product. For instance, based on body tracking techniques, a customer might be able to select from either a small, medium, or large jacket. By ensuring that the mapped model of the coat remains the same, the customer can be presented with different “fits” of the coat on the customer's mapped avatar body.

In additional embodiments, the customers can take this 3D model of themselves and the corresponding products, and without physically turning around, can turn just the avatar (e.g., through menu selection or through gesture control and corresponding animations, such as turning an arm in a circle to show an opposing view). In still further or more simplified embodiments, images of the customer can be saved so the customer can take a picture from the back, turn around, and view the saved image. Saved images can also be shared with other users (e.g., using social media, printouts, etc.). A social media app, for example, could communicate between the customer's smartphone and the system 600, allowing for the sharing of information.

In accordance with still another embodiment of the present invention, in addition to merely being an anonymous “browsing” system, the interactive holographic retail system 600 herein may also provide various manners for actually completing a purchase. For instance, a final purchase can be made through the customer's mobile device or through a self-service kiosk (e.g., credit card entry, cash entry, etc.), shipping the product to the customer's house or other selected address. For example, once a particular holographic product is selected (e.g., via gesture control), the final purchase may be made through secure communication on the customer's mobile device, either driven by communication with the system 600, or else by entering in a specific order number into a payment app (or by texting a specific number).

Specifically, various payment options may be used with the system 600 herein. For example, near-field communication (NFC) technology may be used to make and accept payments, such as from a customer's smartphone, smart-watch, etc. The techniques herein may also allow customers to have a link texted to their phone or an email sent to the customer where the purchase can then be completed from there as an online purchase, having pre-populated the product list (shopping cart). For example, after a customer is browsing through products, and either decides to pay later or his forced to interrupt the shopping session before being able to complete a transaction, the system could ask for the customer's phone number, and sends a text message having a link that would essentially be a tracked link to the shopping cart of the web site of that store with the selected products/items already loaded.

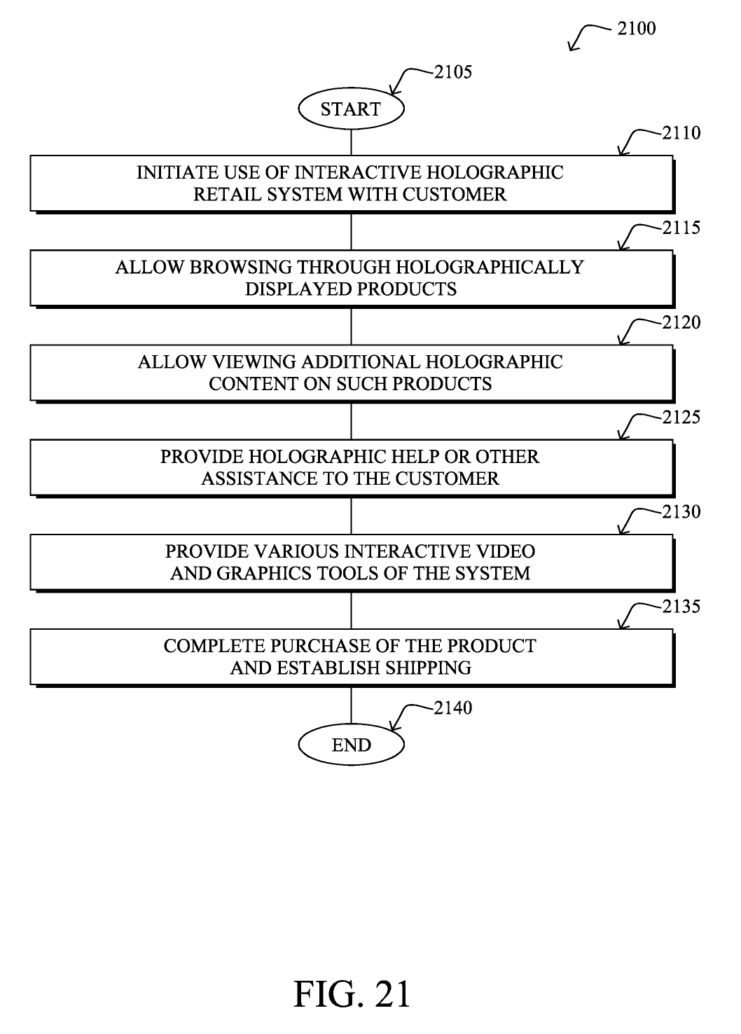

FIG. 21 illustrates an example simplified procedure for generally using a holographic interactive retail system in accordance with one or more embodiments described herein. The simplified procedure 2100 may start at step 2105, and continues to step 2110, where a user initiates use of the system 600 as a customer 660, such as by being detected in proximity of the system, selecting an option on a user interface, etc. In step 2115, the customer may browse through holographically displayed products, and may also view additional content on such products in step 2120. Any help or other assistance may also be provided to the customer in step 2125, such as from a virtual representative, avatar, etc. Also, in step 2130, the customer may use various interactive video and graphics tools of the system, such as viewing themselves with controlled objects/products, or else using full avatar mapping to render a 3D version of themselves wearing the selected products. In step 2135, the customer may make a purchase of the product, and if the associated store is otherwise closed (or not near the system), the product(s) may be paid for and shipped to a desired location. The simplified procedure ends in step 2140.

It should be noted that while certain steps within procedures 1500 and 2100 may be optional as described above, the steps shown in FIGS. 15 and 21 are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures 1500 and 2100 are described separately, certain steps from each procedure may be incorporated into each other procedure, and the procedures are not meant to be mutually exclusive.

Advantageously, the techniques herein provide for a holographic interactive retail system. In particular, as mentioned above, the techniques described herein provide for a holographic image (e.g., Pepper's Ghost Illusion) to be used in a retail setting (e.g., storefront window), which, when combined with gesture control, allows people to walk up to the system and search for and buy products. In this manner, a new type of retail experience is created for customers, which can be performed during open store hours (e.g., to alleviate lines at check-out), or else after-hours when the store is closed for “live” business. Additionally, the enhanced features, such as the product placement on the customer, expand the retail experience for customers.

While there have been shown and described illustrative embodiments, it is to be understood that various other adaptations and modifications may be made within the spirit and scope of the embodiments herein. For example, the embodiments described herein may be used with holographic projection images produced from a variety of sources, such as live-streamed, pre-recorded, re-constructed, computer-generated, and so on. Also, any reference to “video” or “image” or “picture” need not limit the embodiments to whether they are motion or time-sequence photography or still images, etc. Moreover, any holographic imagery techniques may be used herein, and the illustrations provided above are merely example embodiments, whether for two-dimensional or three-dimensional holographic images.

Further, the embodiments herein may generally be performed in connection with one or more computing devices (e.g., personal computers, laptops, servers, specifically configured computers, cloud-based computing devices, cameras, etc.), which may be interconnected via various local and/or network connections. Various actions described herein may be related specifically to one or more of the devices, though any reference to particular type of device herein is not meant to limit the scope of the embodiments herein.

The foregoing description has been directed to specific embodiments. It will be apparent, however, that other variations and modifications may be made to the described embodiments, with the attainment of some or all of their advantages. For instance, it is expressly contemplated that certain components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
initiating use of a holographic interactive retail system with a customer;
holographically displaying products to the customer on a holographic display of the holographic interactive retail system; and
interacting with the customer to control the holographically displayed products on the holographic display of the holographic interactive retail system.

2. The method as in claim 1, further comprising:
detecting motions of the customer; and
using the detected motions for gesture control of the holographically displayed products.

3. The method as in claim 2, wherein gesture control is selected from a group consisting of: browsing through a series of items; saving items; removing saved items; changing views of an item; ordering an item; providing more information about an item; and grabbing pop-up coupons on the display holographic display.

4. The method as in claim 1, further comprising:
detecting facial expressions of the customer; and
interacting with the customer based on the detected facial expressions.

5. The method as in claim 4, wherein interacting comprises presenting particular products to the customer based on perceived facial expressions detected during display of other products.

6. The method as in claim 1, further comprising:
completing a purchase transaction between the holographic interactive retail system and the customer.

7. The method as in claim 1, wherein initiating comprises detecting the customer within a given proximity of the holographic interactive retail system.

8. The method as in claim 1, further comprising:
detecting the customer within a particular depth range from the holographic interactive retail system.

9. The method as in claim 1, wherein holographically displaying products comprises a Pepper's Ghost Illusion.

10. The method as in claim 1, further comprising:
capturing an image of the customer; and
holographically displaying the image of the customer on the holographic display of the holographic interactive retail system.

11. The method as in claim 10, further comprising:
holographically displaying the image of the customer along with the holographically displayed products.

12. The method as in claim 11, further comprising:
rendering the holographically displayed image of the customer to appear wearing the holographically displayed products.

13. The method as in claim 12, wherein rendering comprises avatar-based mapping of the holographically displayed products to the holographically displayed image of the customer.

14. The method as in claim 10, wherein the holographically displayed image of the customer moves in real-time along with movement of the customer.

15. The method as in claim 10, further comprising:
detecting a size of the customer; and
presenting particular products to the customer based on the detected size.

16. A holographic interactive retail system, comprising:
a user interface configured to interact with a customer;
a holographic display; and
a computer configured to holographically displaying products to the customer on the holographic display, and to interacting with the customer through the user interface to control the holographically displayed products on the holographic display of the holographic interactive retail system.

17. The system as in claim 16, further comprising:
a video input system configured to detecting motions of the customer; and
wherein the computer is configured to use the detected motions for gesture control of the holographically displayed products.

18. The system as in claim 16, further comprising:
a video input system configured to detect facial expressions of the customer; and
wherein the computer is configured to interact with the customer based on the detected facial expressions.

19. The system as in claim 16, further comprising:
a video input system configured to capture an image of the customer; and
wherein the computer is configured to holographically display the image of the customer on the holographic display along with the holographically displayed products.

20. The system as in claim 19, wherein the computer is configured to render the holographically displayed image of the customer to appear wearing the holographically displayed products.
